(19) United States
(12) Patent Application Publication
(10) Pub. No.: US 2005/0128427 A1
(43) Pub. Date: Jun. 16, 2005

(54) Eyeglasses enhancement

(76) Inventor: Jinn-Shyan Hwang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/735,834

(22) Filed: Dec. 16, 2003

(51) Int. Cl. G02C 7/08

(52) U.S. Cl. 351/57

(57) ABSTRACT

An eyeglasses enhancement comprised of a supplementary lens frame additionally installed on an eyeglass temple. The supplementary lens frame is folded and unfolded on the eyeglass temple. When unfolded, the supplementary lens fitted therein is angled freely into position in front of the main lens. Due to the specific optical characteristics of the main lens, the unfolded supplementary lens allows the eyeglass wearer to have two different focal lengths available to thereby simply, conveniently and, furthermore, clearly view objects at close distances.

### BACKGROUND OF THE INVENTION

1) Field of the Invention

The invention herein relates to complementary lenses that are mounted as an accessory onto eyewear frames, specifically an eyeglasses enhancement in which a supplementary lens frame is additionally installed onto one or both eyeglass temples.

2) Description of the Prior Art

When wearers that have two pairs of different focal length eyeglasses (such as those having both myopia and presbyopia or both hyperopia and presbyopia) look at objects or reading material up close, they must typically first remove the glasses for farsightedness and switch to the presbyopic pair or first replace the glasses for nearsightedness with the ones for presbyopia in order to see clearly. However, wearers that own two pairs of glasses each with different prescriptions know that after obtaining corrective eyeglasses for nearsightedness (or farsightedness) and presbyopia to view things clearly, two pairs of glasses must be carried at all times, which is not only uneconomical in terms of having eyewear made, but also has the drawbacks of being troublesome and inconvenient in terms of handling and operation.

To improve the said drawbacks, so-called compound-type lenses are currently available on the market. These two-way compound lenses for nearsightedness (or farsightedness) and presbyopia are fabricated by a special optical process. However, since the production of such lenses requires precision and is complicated, they are expensive and economically disadvantageous. To accommodate different object viewing distances, the user must adjust their angle of sight to see things clearly through the lenses, which easily results in eye fatigue during usage. To wear such lenses, the user has to discard an original pair of eyeglasses and pay again to have another one made. And, as myopic (or hyperopic) or presbyopic prescriptions change, the user must purchase new and costly lenses from time to time, which is actual terms is obviously uneconomical.

As such, to wearers that have two pairs of different focal length eyeglasses, the said conventional glasses are not the most practical to utilize, remaining inadequate with shortcomings that await improvement.

### SUMMARY OF THE INVENTION

The primary objective of the invention herein is to provide an eyeglasses enhancement, wherein the said supplementary lens frame freely unfolds from the eyeglass temple; when unfolded, the supplementary lens frame is angled freely into position in front of the main lens and due to the specific optical characteristics of the main lens, the unfolded supplementary lens allows the eyeglass wearer to have two different focal lengths available to thereby simply, conveniently and, furthermore, clearly view objects at close distance.

Another objective of the invention herein is to provide an eyeglasses enhancement, wherein the said supplementary lens frame freely folds against the eyeglass temple such that it does not hinder the predetermined use of the eyeglasses.

Yet another objective of the invention herein is to provide an eyeglasses enhancement, wherein the said supplementary lens frame is attached to the eyeglass temple and the supplementary lens fitted therein complements the specific application of the main lens, the extremely simple, convenient and, furthermore, economical and opportune adjustment arrangement providing the wearers having two pairs of different focal length eyeglasses more utilization convenience and economic advantages.

Still another objective of the invention herein is to provide an eyeglasses enhancement that affords easy and convenient simplicity, installation, and utilization such that wearers having two pairs of different focal length eyeglasses view objects at close distances easily, conveniently, and clearly, the present invention thereby meeting the criteria of practical utility, refinement, and progressiveness and, furthermore, such an eyeglasses enhancement has not been available previously.

### BRIEF DESCRIPTION OF THE DRAWINGS

FIG. 1 is an isometric drawing of the invention herein installed on a pair of eyeglasses.

FIG. 2 is an isometric drawing of the invention herein.

FIG. 3 is an exploded drawing of the invention herein.

FIG. 4 is an orthographic drawing of the invention herein when unfolded in front of the main lens, as viewed from the top (1).

FIG. 5 is an orthographic drawing of the invention herein when unfolded in front of the main lens, as viewed from the top (2).

FIG. 6 is an orthographic drawing of the invention herein when unfolded in front of the main lens, as viewed from the front.

FIG. 7 is an orthographic drawing of the invention herein when unfolded in front of the main lens, as viewed from the side.

FIG. 8 is an orthographic drawing of the invention herein when folded at the side of the eyeglass temple.

### DETAILED DESCRIPTION OF THE INVENTION

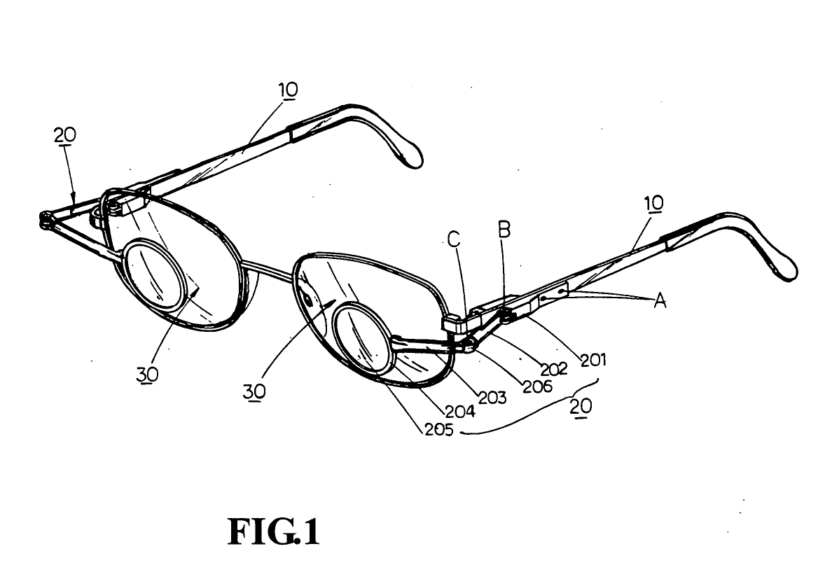

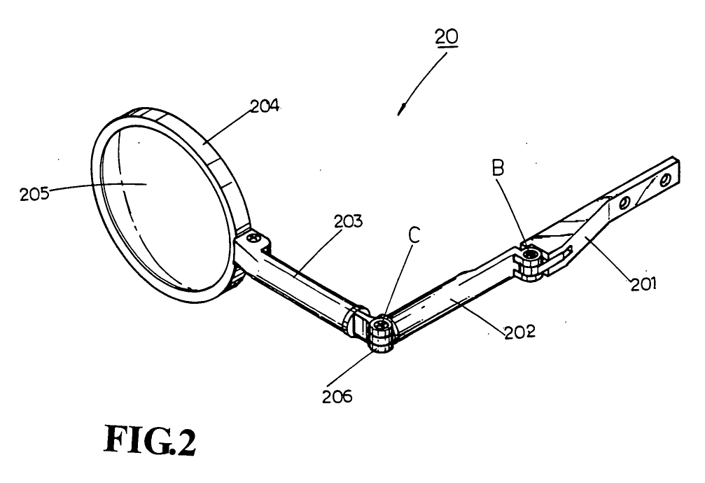

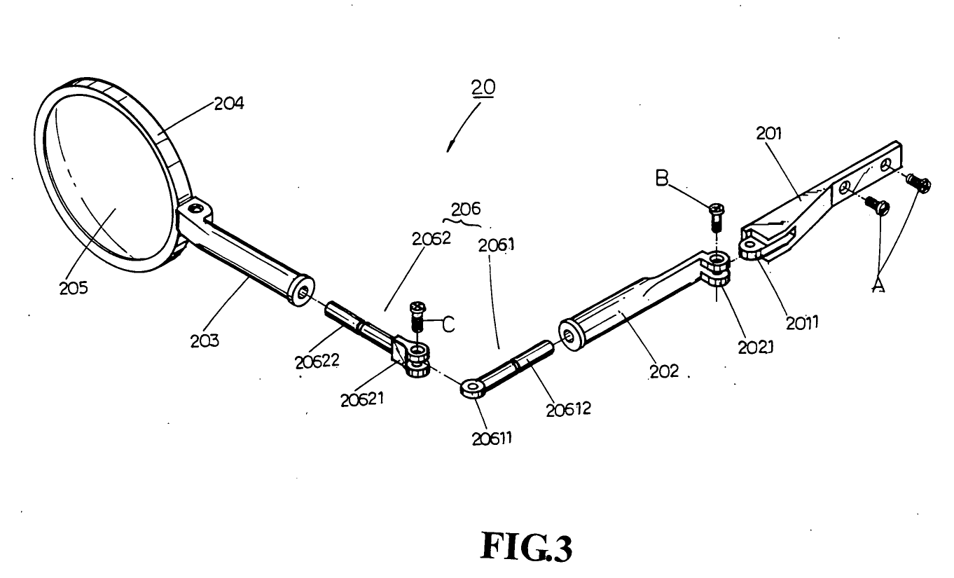

Referring to FIG. 1, FIG. 2, and FIG. 3, the eyeglasses enhancement of the invention herein is comprised of a supplementary lens frame 20 additionally installed on an eyeglass temple 10. The said supplementary lens frame 20 consists of a plurality of members 201, 202, and 203 (the invention herein uses three members as an example embodiment) supporting a supplementary lens wire 204, a supplementary lens 205, and a universal joint 206. Wherein, the said member 201 situated at the rearmost extent of the posterior extremity is fastened, clipped, or attached by means of any medium to the eyeglass temple 10 (in the invention herein, fastening by means of screw A serves as an example embodiment); the said member 203 located at the leading extent of the anterior extremity provides for holding the supplementary lens wire 204; the said first middle member 202 has a hinge mount 2021 at its rear end that is movably conjoined by means of a screw B to a locating mount 2011 at the front end of the posterior extremity member 201 and is capable swinging forward and backward a minimum of 180 degrees; the said universal joint 206 consists of a male hinge component 2061 and female hinge component 2062, the proximal extremities 20611 and 20621 of the said male and female hinge components 2061 and 2062 are movably conjoined by means of a screw C and capable of being swung a minimum of 180 degrees, and the distal extremities 20612 and 20622 are respectively conjoined in a state of free rotation to the front end of the first middle member 202 and the rear end of the anterior extremity member 203, enabling the installation of the said anterior extremity member 203 onto the supplementary lens wire 204 and its free angular rotation and swinging.

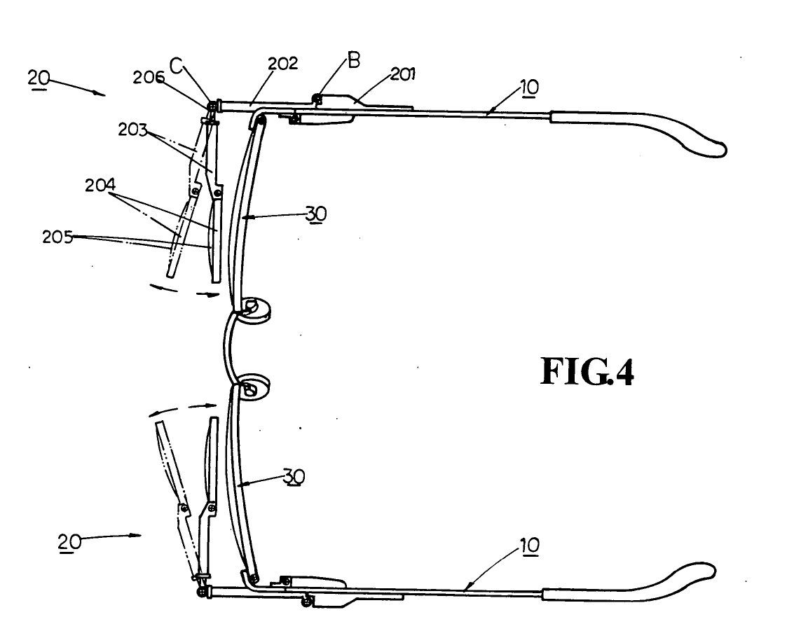

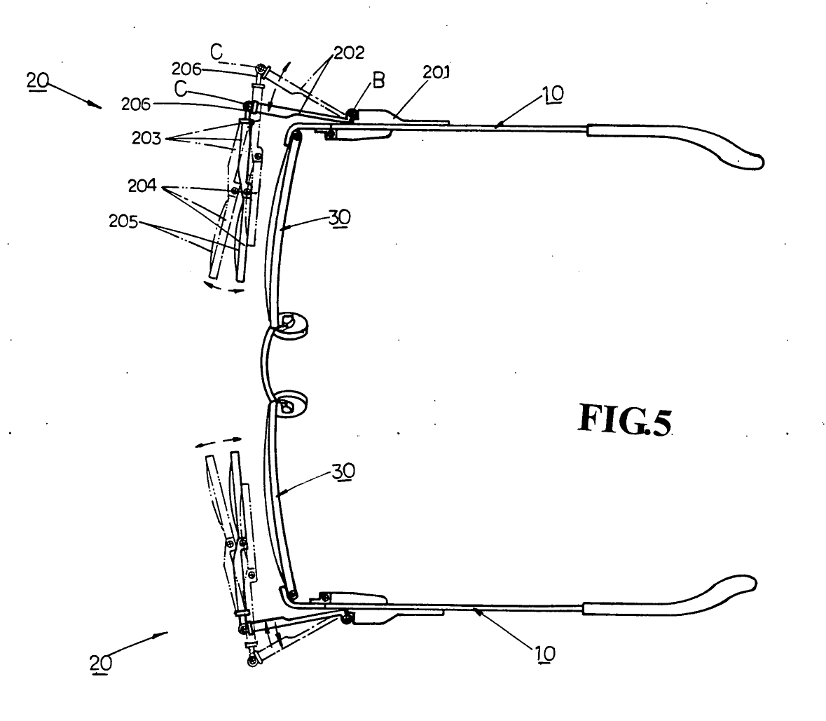

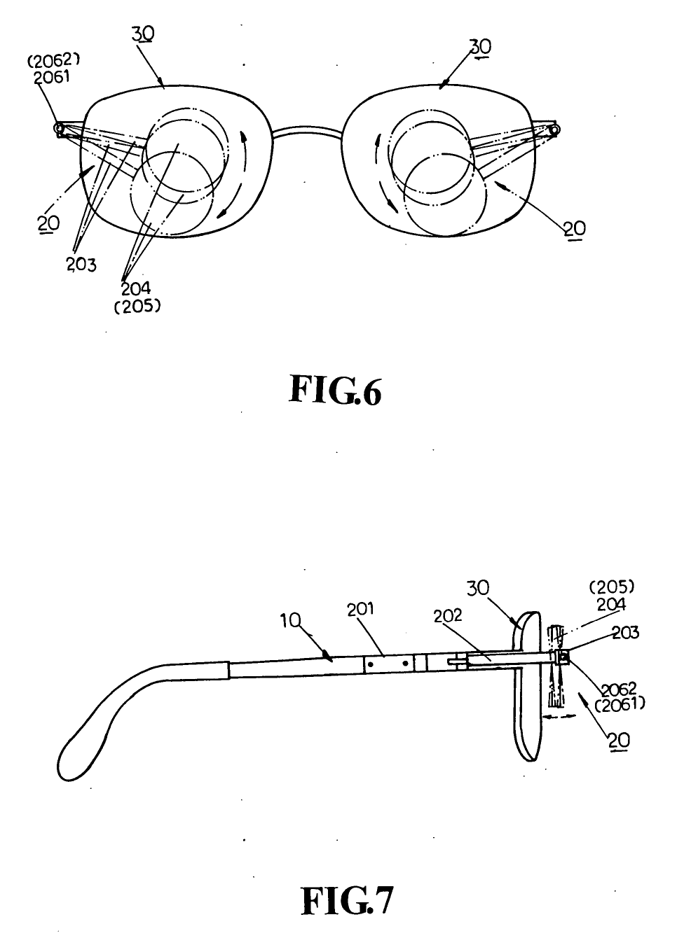

Utilizing the said arrangement, referring to FIG. 4, FIG. 5, FIG. 6, and FIG. 7, after the posterior extremity member 201 is installed onto the eyeglass temple 10, since the rear end of the first middle member 202 swings forward on a pivot point at screw B and the rear end of the anterior extremity member 203 swings on a pivot point at the universal joint 206 screw C, the supplementary lens frame 20 of the invention herein swings forward to unfold, enabling the supplementary lens 205 fitted in the said supplementary lens wire 204 to become positioned directly in front of the main lens 30 and, furthermore, adjusted angularly forward and backward according to actual requirements (as shown in FIG. 4); as indicated in FIG. 5, since the said first middle member 202 swings to the left and right on the pivot point at screw B and the said anterior extremity member 203 swings forward and backward on the pivot point at the universal joint 206 screw C, the said supplementary lens 205 in the said supplementary lens wire 204 positioned in front of the main lens 30, in addition to forward and backward angular adjustment can also be adjusted to the left and right, enabling appropriate adjustment to the left and right position in front of the main lens 30 as necessary; additionally, as indicated in FIG. 6, since the rear extremity of the said universal joint 206 male hinge component 2061 (or female hinge component 2062) is insertionally positioned in a state of free rotation at the first middle member 202 and the anterior extremity member 203 supplementary lens wire 204 installed at the said universal joint 206 female hinge component 2062 (or male hinge component 2061) is capable of free rotation, then as per actual requirements, the said supplementary lens wire 204 supplementary lens 205 unfolded in front of the main lens 30, in addition to the said forward and backward angular adjustment and adjustment to the left and right, can also be adjusted upward and downward; as indicated in FIG. 7, since the rear extremity of the said universal joint 206 female hinge component 2062 is insertionally positioned in a state of free rotation at the anterior extremity member 203, and the supplementary lens wire 204 installed at said anterior extremity member 203 is capable of free rotation, then as per actual requirements, the said supplementary lens wire 204 supplementary lens 205 unfolded in front of the main lens 30, in addition to the said forward and backward angular adjustment, adjustment to the left and right, and adjustment upward and downward, can also be angularly adjusted inward and outward.

In other words, the said supplementary lens wire 204 and supplementary lens 205 fitted therein is simple and convenient to unfold and, furthermore, rapidly positioned anywhere in front of the main lens 30, and with each of the two lenses having differing focal lengths, the supplementary lens 205 facilitates the clear visual perception of close objects.

In the said arrangement, the said main lens 30 and supplementary lens 20 are in a complementary relationship such that said wearers having two pairs of different focal length eyeglasses clearly view objects at close distances; for example, when utilized by a user having both myopia and presbyopia, if the main lens 30 is a concave lens of −500 degrees, then the said supplementary lens 205 must be a convex lens ground to +200 degrees and given the dioptric combination of the two, the user views distant objects normally through the main lens 30, but when viewing objects at close distances, it is only necessary to simply unfold the supplementary lens 205 to a predetermined position in front of the main lens 30 to immediately achieve the expected clarity; when utilized by a user having both hyperopia and presbyopia, if the main lens 30 is a convex lens of +100 degrees, then the said supplementary lens 205 has to be a convex lens ground to +200 degrees, the combined optical effect of the two allowing the user to view distant objects normally through the main lens 30 and view objects at close distances with the expected clarity by merely unfolding the supplementary lens 205 to a predetermined position in front of the main lens 30. As stated, the said supplementary lens 205 is ground to complement the main lens 30 supporting a specific application and thus the lens prescription is varied according to actual requirements.

As such, since the supplementary lens frame 20 of the invention herein consists of a supplementary lens 205 that readily unfolds in front the main lens 30 to augment the viewing of objects, when utilized by highly skilled craftsmen (such as watchmakers) or microscopic object observers (such as laboratory workers), the said supplementary lens wire 204 only has to be installed with convex lens of a predetermined high-degree (times magnification) rating to easily achieve clear observation capability at a given close distance, a significant improvement of the prior art which requires a tall convex lens that easily causes eye fatigue, discomfort, operating difficulty, and other drawbacks.

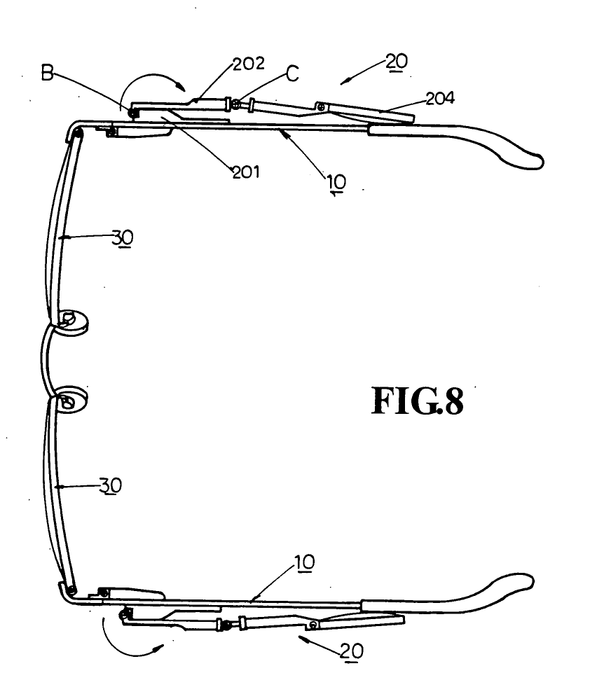

Referring to FIG. 8, since the said first middle member 202 swings forward and backward on the pivot point at screw B and the said anterior extremity member 203 swings on the pivot point at screw C, when the eyeglass wearer is not using the supplementary lens frame 20 or not using the eyeglasses, it is only necessary to rotate the said first middle member 202, following which the anterior extremity member 203 swings down against the eyeglass temple 10 to thereby immediately fold the present invention in a simple procedure and, furthermore, the convenience is provided without hindering the normal use of the eyeglasses.

It is worth mentioning that since the arrangement of the supplementary lens frame 20 does not interfere with the structure of conventional eyeglasses and, furthermore, the invention herein is easily installed on the eyeglass temple of existent pairs of eyeglasses, wearers now using two pairs of different focal length eyeglasses can immediately and conveniently see far and close objects, which is among the design advantages of the invention herein.

If required during actual utilization, the supplementary lens frame 20 of the present invention can be installed on two eyeglass temples 10 or just installed on a single eyeglass temple 10.

1. An eyeglasses enhancement, the features of which include a supplementary lens frame installed on an eyeglass temple, the said supplementary lens frame consisting of a plurality of members supporting a supplementary lens wire, a supplementary lens, and a universal joint in an arrangement that is capable of unfolding and folding; when unfolded, the said supplementary lens fitted in the said supplementary lens wire can be positioned anywhere in front of a main lens, and when folded, each said member, and the said supplementary lens wire along with the said supplementary lens, is postured against the said eyeglass temple.

2. As mentioned in claim 1 of the eyeglasses enhancement invention herein, the said member at the posterior extremity is fastened, clipped, or attached by means of any medium to the said eyeglass temple.

3. As mentioned in claim 1 of the eyeglasses enhancement invention herein, the said member located at the anterior extremity provides for holding the said supplementary lens wire.

4. As mentioned in claim 1 and claim 2 of the eyeglasses enhancement invention herein, the said first middle member has a hinge mount at its rear end that is movably conjoined by means of a screw to a locating mount of the said posterior extremity member and is capable swinging forward and rearward a minimum of 180 degrees.

5. As mentioned in claim 1 and claim 3 of the eyeglasses enhancement invention herein, the said universal joint is installed between the said anterior extremity member and the said first middle member.

6. As mentioned in claim 1 of the eyeglasses enhancement invention herein, the said supplementary lens frame of the present invention can be installed on two said eyeglass temples or just installed on a single said eyeglass temple.
